(19) United States
(12) Patent Application Publication
(10) Pub. No.: US 2004/0114258 A1
(43) Pub. Date: Jun. 17, 2004

(54) Device and method for combining dynamic mathematical expressions and other multimedia objects within a document

(76) Inventors: Richard Alexander Harris III, Shady Shores, TX (US); Michael Edward Hosea, Wylie, TX (US)

Correspondence Address: TEXAS INSTRUMENTS INCORPORATED, P O BOX 655474, M/S 3999, DALLAS, TX, 75265

(21) Appl. No.: 10/322,118

(22) Filed: Dec. 17, 2002

(51) Int. Cl. G06F 9/44; G02B 5/08; G02B 7/18

(52) U.S. Cl. 359/841

(57) ABSTRACT

A computing device and method for combining dynamic mathematical expressions and other multimedia objects within a text document. The computing device includes memory adapted to store software for creating and editing a document comprising text and at least one mathematical expression. The computing device includes a processor adapted to run the software and a user interface that may be activated to create and edit a document while at least portions of the document are displayed on a display screen. The evaluation order of mathematical expressions may be explicitly modified and static mathematical expressions may be converted to dynamic mathematical expressions, and vice versa. Users can choose from a palette of mathematical patterns and modify them for a particular application, or create custom mathematical patterns. Inputs and outputs of dynamic mathematical expressions may be separated, with text and/or other multimedia objects inserted between them.

### CROSS-REFERENCE TO RELATED APPLICATIONS

This application relates to co-pending and commonly assigned patent application Ser. No. 10/232,068, filed on Aug. 30, 2002, entitled “Inserting Complex Comments in a Document,” which is hereby incorporated herein by reference.

### TECHNICAL FIELD

The present invention relates generally to computers and software for computers, and more particularly to a device and method for combining dynamic mathematical expressions and other multimedia objects within a document on a computing device.

### BACKGROUND

Word processing software such as Word and WordPerfect is commonly used on desktop computers such as personal computers (PC's), laptop and notebook computers. Compound documents are a more recent development in document processing software. A compound document is a document that contains information in various formats embedded in the document. For example, a compound document may contain data in text format, charts and/or numerical format.

Some compound document applications support embedded objects that are linked in a specific evaluation/update order. Typically, there is a sequence of calculations, some of which may depend on definitions or computations performed by embedded objects that are before it in the ordering. One such compound document application is Texas Instruments Incorporated's TI InterActive!™, which is an educational software package for desktop computers that allows users to create compound documents with live math objects. As variables in equations are changed by a user, the document changes in real time. Other objects may also be inserted into a text documents, such as images, graphs, and math variable slider controls.

However, this software has some limitations. The evaluation order of equations is limited to a left-to-right and top-to-bottom order, so that mathematical expressions must be placed above or to the left of graphs in a document. For example, object A comes before object B in the sequence of evaluations/updates if object A is above or to the left of object B, where some specific point in each object's rectangle is chosen for the point of comparison. This prevents the user from putting data at the end of the document or defining a function below its graph, as in a caption for the graph. In addition, a mathematical object usually comprises two mathematical expressions, an input and an output. These inputs and outputs of mathematical objects may not be separated.

### SUMMARY OF THE INVENTION

Embodiments of the present invention provide a device and method for creating and editing documents that combine text with dynamic mathematical expressions and multimedia objects. There are many other novel features of embodiments of the invention, to be described further herein.

In accordance with a preferred embodiment of the present invention, a computing device includes memory adapted to store software for creating and editing a document comprising text and at least two mathematical expressions embedded within the document, the mathematical expressions having a first evaluation order. The computing device also includes a processor adapted to run the software, and a user interface. The user interface may be activated to create and edit the document while at least portions of the document are displayed on a display screen. The user interface may be used to explicitly modify the first evaluation order to a second evaluation order, the second evaluation order being different from the first evaluation order.

In accordance with another preferred embodiment of the present invention, a computing device includes memory adapted to store software for creating and editing a document comprising text and at least one mathematical expression embedded within the document, wherein the mathematical expression comprises a static mathematical expression or a dynamic mathematical expression. A static mathematical expression is visually distinguishable from a dynamic mathematical expression. The computing device also includes a processor adapted to run the software, and a user interface. The user interface may be activated to create and edit the document while at least portions of the document are displayed on a display screen. A dynamic mathematical expression may be converted to a static mathematical expression, and a static mathematical expression may be converted to a dynamic mathematical expression, using the user interface.

In yet another embodiment of the invention, a computing device includes memory adapted to store software for creating and editing a document comprising text and at least one dynamic mathematical expression embedded within the document. The dynamic mathematical expression has an input and an output. The computing device also includes a processor adapted to run the software, and a user interface. The user interface may be activated to create and edit the document while at least portions of the document are displayed on a display screen. The input and output of the dynamic mathematical expression may be separated by text or at least one multimedia object using the user interface.

In accordance with another preferred embodiment of the present invention, a computing device includes a display screen, memory adapted to store software for creating and editing a document comprising text and at least one mathematical expression, a processor adapted to run the software, and a user interface. The user interface may be activated to create and edit the document while at least portions of the document are displayed on the display screen. The user interface provides a palette including a plurality of selectable mathematical patterns, and selected mathematical patterns may be edited to create custom mathematical patterns using the user interface.

In accordance with yet another preferred embodiment of the present invention, a handheld computing device includes a housing, the housing having dimensions such that the handheld computing device may be operated while being held in the hand of a user. The handheld computing device includes a display screen disposed on the exterior of the housing, the display screen including a user interface. The user interface may be activated to create and edit the document while at least portions of the document are displayed. The handheld computing device includes memory adapted to store software for creating and editing a document comprising text and at least one dynamic mathematical expression, and a processor adapted to run the software.

Another embodiment of the present invention includes a method of creating and editing a document. The method includes providing a handheld computing device, the handheld computing device including a user interface having a display screen, and editing software adapted to create a document comprising text and at least one dynamic mathematical expression. The method includes creating text portions of the document, and embedding the at least one dynamic mathematical expression within the text portions of the document.

In yet another embodiment of the invention, a method of creating and editing a document includes providing a computing device, the computing device including a processor, a user interface and memory storing editing software, wherein the computing device is adapted to create a document comprising text and at least two mathematical expressions having a first evaluation order. The method includes creating text portions of the document, embedding the at least two mathematical expressions within the text portions of the document, and explicitly modifying the first evaluation order of the at least two mathematical expressions to a second evaluation order, wherein the second evaluation order is different from the first evaluation order.

In another embodiment of the invention, a method of creating and editing a document includes providing a computing device, the computing device including a processor, a user interface and memory storing editing software adapted to create a document comprising text and at least one mathematical expression embedded within the document, wherein the mathematical expression comprises a static mathematical expression or a dynamic mathematical expression, wherein a static mathematical expression is visually distinguishable from a dynamic mathematical expression. The method includes creating text portions of the document, embedding the at least static or dynamic mathematical expression within the text portions of the document, and converting the static mathematical expression to a dynamic mathematical expression, or converting the dynamic mathematical expression to a static mathematical expression.

In accordance with yet another embodiment of the present invention, a method of creating and editing a document includes providing a computing device, the computing device including a processor, a user interface and memory storing editing software adapted to create a document comprising text and at least one dynamic mathematical expression embedded within the document, the dynamic mathematical expression having an input and an output. The method includes creating text portions of the document, embedding the at least one dynamic mathematical expression within the text portions of the document, and separating the input and output of the dynamic mathematical expression using the user interface.

Another embodiment of the present invention includes a method of creating and editing a document. The method includes providing a computing device, the computing device including a processor, a user interface and memory storing editing software adapted to create a document comprising text and at least one dynamic mathematical expression embedded within the document. The memory includes a palette of selectable mathematical patterns. The method includes creating text portions of the document, selecting a mathematical pattern from the palette, editing the mathematical pattern to create a custom mathematical pattern, and storing the custom mathematical pattern in memory.

In yet another embodiment of the invention, an algorithm for mathematical pattern selection within a document includes defining a plurality of mathematical patterns, each pattern definitions having at least one empty field for a sub-expression. The pattern definitions are stored in a computing device memory, and the selectable plurality of pattern definitions are displayed on a user interface. The user may select a pattern definition, and a subexpression for the at least one empty field of the pattern definition using the user interface. As the user edits the pattern definition, a two-dimensional pattern definition and a one-dimensional semantic representation of the two-dimensional pattern definition are simultaneously created.

An advantage of a preferred embodiment of the present invention is the ability to embed many types of interactive mathematical expressions and non-text objects within a text document of a handheld computing device. The mathematical expressions may interact with one another or with non-text objects, improving the quality of and providing flexibility in the arrangement of documents and presentations generated by the computing device.

A further advantage of a preferred embodiment of the present invention is the ability to change the evaluation order, either implicitly or explicitly, of mathematical expressions embedded within text documents. Mathematical expressions may be moved around in a document, and the evaluation order is updated as the expressions are moved. The inputs of mathematical expressions can be separated from the outputs, and the mathematical expression inputs and outputs may be moved to another location in the document.

Yet another advantage of a preferred embodiment of the present invention is the ability to convert live (e.g., dynamic) mathematical objects to dead (e.g., static) mathematical objects, or vice versa, either implicitly or explicitly.

Another advantage includes providing a plurality of pre-programmed mathematical patterns, which may be customized and altered by the user. As the user edits the pattern definition, a two-dimensional pattern definition and a one-dimensional semantic representation of the two-dimensional pattern definition are simultaneously created. There are many other advantages and features of embodiments of the present invention, to be described further herein.

The foregoing has outlined rather broadly features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a handheld computing device upon which embodiments of the invention may be implemented;

FIG. 2 shows a text document including dead or “static” mathematical expressions and embedded dynamic or ‘live’ mathematical expressions in “1D” format (e.g., visually on one line) displayed on the screen of the handheld device shown in FIG. 1;

FIG. 3a shows the live mathematical expressions of FIG. 2 in a “2D” (e.g., “pretty print”) format;

FIG. 3b illustrates that a user can activate a context menu to select a display mode for live mathematical expressions;

FIG. 3c illustrates a dialog box that can be activated by the user that allows the user to view the input and output of mathematical expressions in either 1D (‘plain text’) or 2D (‘pretty print”);

FIG. 4a illustrates the movement of the mathematical expression to another position within the text document, wherein the evaluation order is implicitly changed accordingly to yield a different result as it was prior to moving the expression;

FIG. 4b shows how a user may make a selection to view the evaluation order;

FIG. 4c shows numbers indicating the evaluation order of the live mathematical expressions;

FIG. 4d shows that inserting another live mathematical expression implicitly changes the evaluation order of the following live mathematical expressions;

FIG. 5a illustrates explicit evaluation order modification that may be implemented by brining up a context menu;

FIG. 5b illustrates a docked dialog bar that is brought up at the bottom of the screen display area of the handheld device when the evaluation order button of the context menu of FIG. 5a is selected;

FIG. 5c illustrates the change to the evaluation order and results of mathematical expression upon altering the update ordinal in the docked dialog bar of FIG. 5b;

FIG. 6a shows a graph of a mathematical expression embedded within a text document;

FIG. 6b shows a graph of a mathematical expression embedded within a text document, with the equation following the graph;

FIG. 7 shows a math slider for a variable of the graph shown in FIG. 6a embedded within the text document;

FIG. 8 illustrates an audio clip icon embedded within the text document;

FIG. 9 illustrates a list of available mathematical expressions, operators, and symbols;

FIG. 10a shows a pattern for a summation mathematical expression;

FIG. 10b illustrates the expression of FIG. 10a after the user inputs the pattern subexpressions;

FIG. 10c shows the mathematical expression of FIG. 10a after a user has modified it;

FIG. 11 is a flow chart for a pattern editing algorithm in accordance with an embodiment of the invention;

FIG. 12 illustrates a block diagram of the system architecture of the editor;

FIG. 13 illustrates a more detailed view of the block diagram of FIG. 12, showing the application object and document object models; and

FIG. 14 shows a block diagram of the handheld computing device adapted to implement the editor, in accordance with embodiments of the invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Prior art graphing calculators and handheld devices have separate application environments that are difficult to merge with one another. For example, a user must write a program or script to navigate from one application environment to another, such as when presenting explanatory text, the presentation of some data, and a graph. What is needed in the art is a computing device having an editor and runtime environment that facilitates self-contained, interactive activities and objects.

Embodiments of the present invention provide an integrated authoring and runtime environment that allows previously separate features of graphing calculators and other handheld devices to be combined in a single self-contained, interactive document. The present invention will be described with respect to preferred embodiments in a specific context, namely a handheld computing device such as a graphing calculator or personal digital assistant (PDA). Embodiments of the invention may also be implemented, however, on other computers, such as desktop computers or mainframe computers, as examples.

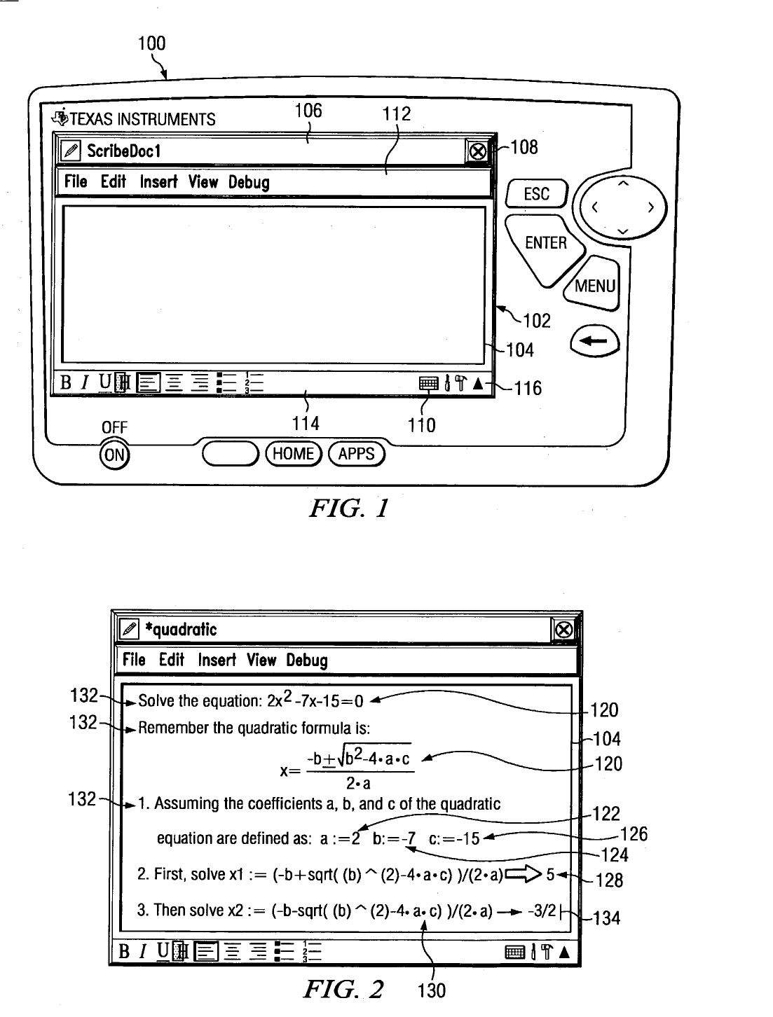

FIG. 1 shows a computer or handheld computing device 100 that incorporates embodiments of the present invention. The device 100 includes an editor or editor module comprising software and/or hardware adapted to perform the document editing functions to be described herein. The editing software may be stored in the memory of the device 100 (see FIG. 15). The device 100 includes a display screen 102 having a display area 104. In this embodiment, the display screen 102 preferably comprises a touch sensitive display adapted to receive input from a stylus or other object (not shown). The display area 104 includes a header bar 106 that shows the application, which comprises a compound document editor tool referred to as “Scribe,” in accordance with embodiments of the invention. The file name of the current open document on the display may also be shown on the header bar. In addition, the header bar may show an icon for closing the tool 108. The display area 104 further includes a button bar 112 that has drop down menus for file, edit, insert and view functions, which in this embodiment is located at the top of the display area 104. The display area 104 may also include a button bar 114, e.g., at the bottom that includes text formatting options, a keyboard icon 110 to bring up a QWERTY universal keyboard on the display for input of characters with the stylus, and an icon 116 that may be activated to view another pop-up menu for inserting text symbols and mathematical expression patterns, for example.

The software and/or hardware module of the device 100 comprises an interactive document editor that is adapted to combine text with non-text objects, to create a compound document. The non-text objects may comprise mathematical expressions and/or multimedia objects, as examples. The multimedia objects may comprise interactive graphs, static images, video images, audio information or information from data collection devices, as examples. The compound document may be displayed, e.g., a portion at a time, in the display area 104. Preferably, other additional extensions may be implemented without having to modify the core software code of the editor 101. In particular, the mathematical expressions and/or multimedia objects may be embedded within a text document. There are many novel features of the interactive document editor 101, to be described further herein.

One feature of embodiments of the present invention is the ability to display mathematical expressions embedded in a text document in either a one dimensional (1D) or two dimensional (2D) format. The mathematical expressions may be treated as objects, and may be contained within a math box, for example. FIG. 2 shows a text document including both “dead” or static mathematical expressions 120 and embedded dynamic or “live” mathematical expressions 122, 124, 126, 128 and 130 displayed on the screen display area 104 of the handheld device 100 shown in FIG. 1. For example, 122 indicates the value of the variable “a”, 124 indicates the value of variable “b”, 126 indicates the value of variable “c”, the equation 128 is used to calculate “x1”, and equation 130 is used to calculate “x2”. The mathematical expressions 120, 124, 126, 128 and 130 are embedded in text 132. The cursor 134 is represented as a vertical bar.

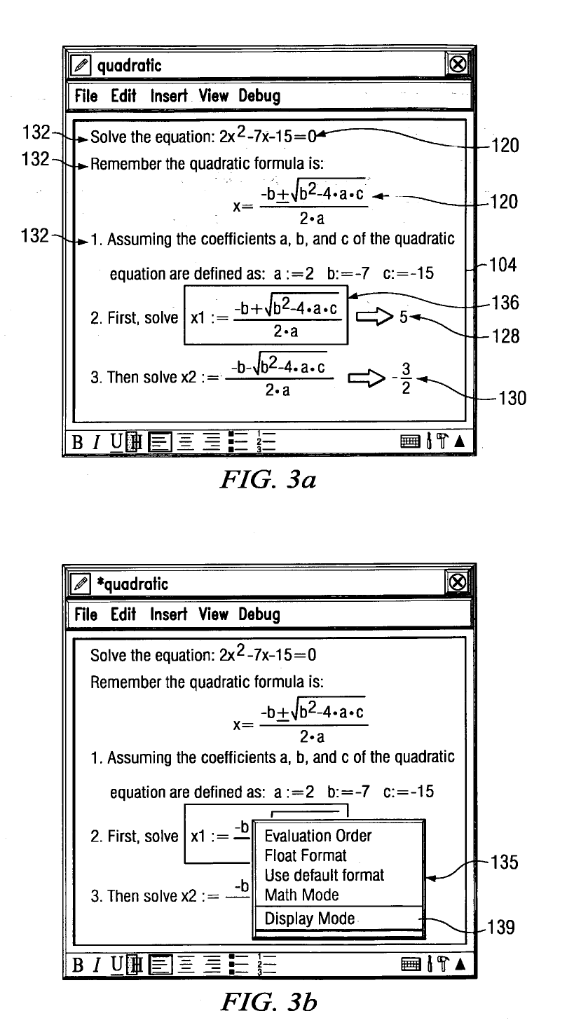

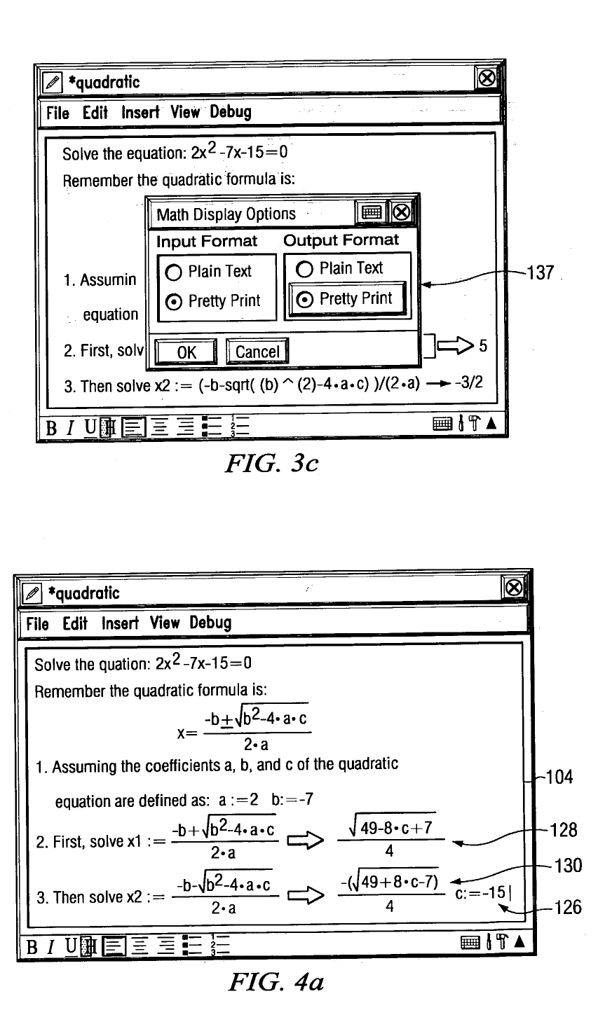

“Live” mathematical expressions are dynamic expressions that are evaluated by a symbolic processor, e.g., a Computer Algebra System (CAS), and a numeric processor of the device 100. The symbolic and numeric processors preferably comprise software that is stored in the memory 196 of the device 100, for example (see FIG. 14). A static expression is one that is not calculated or evaluated by the handheld device 100. Static expressions are preferably clearly visually distinguishable from dynamic expressions. For example, static expressions may be displayed in black or in the same color as the text of the document, while dynamic expressions may be displayed in a color, such as blue. Static expressions may not have a box around them, while dynamic expressions may be surrounded by a box when the cursor is placed in that box (e.g., solid or dashed lines surrounding the expression), (see math box 136 around live expression 128 in FIG. 3a, for example.)

In a preferred embodiment of the invention, “live” mathematical expressions can be converted to “dead” mathematical expressions, and vice versa. To convert a static expression to a dynamic expression, a user selects “static” math with the stylus, and applies the dynamic math pattern to it, which makes the expression become part of the evaluation order. Converting expressions also preferably changes the visual appearance, so the user will recognize whether the expression is dynamic or static. In another embodiment, dynamic mathematical expressions can be cut and pasted elsewhere as a static mathematical expression that is not evaluated and not part of the evaluation order. All or a portion of a dynamic mathematical expression can be copied and pasted in this manner. The user selects all or part of a dynamic math expression, and copies and pastes it to another location in the document, where the expression appears as a static expression.

In FIG. 2, the live mathematical expressions 128 and 130 for “x1” and “x2” are displayed in a 1D format, that is, all on one line. The user alternatively has the ability to select a 2D representation (similar to the way the expression would be drawn on a chalkboard, on two or more lines; also known as “pretty print”) of the mathematical expression, such as the expressions 128 and 130 shown in FIG. 3a. Preferably, the handheld computing device 100 (see FIG. 1) automatically converts 1D live mathematical expressions input into a 2D format. In this preferred configuration, the user may explicitly change the display mode of the expression to 1D.

FIG. 3b illustrates that a user may use the stylus to tap and hold a dynamic mathematical expression, a pop-up context menu 135 is brought up. If the user selects the display mode button 139, the user can select to view the input and output of mathematical expressions in either 1D (‘plain text’) or 2D (‘pretty print”).

FIG. 3c illustrates a pop-up dialog 137 that allows a user of the handheld device 100 to view the input and output of mathematical expressions in either 1D (‘plain text’) or 2D (‘pretty print”). The dialog 137 may be activated, for example, by tapping and holding the mathematical expression with the stylus. One side (of the yield “=>” sign) of the expression may be 1D and the other side may be 2D, for example. The mathematical expression may be edited by the user in either the 1D or 2D format. The editing module preferably includes a “what you see is what you get” (WYSIWYG) MathML presentation markup 2D editor that allows a user to select patterns from a palette and edit them in place with a stylus, for example. 1D format can be mixed with a MathML 2D input, and the editor can convert from 1D format to a 2D representation, or from a 2D to 1D representation.

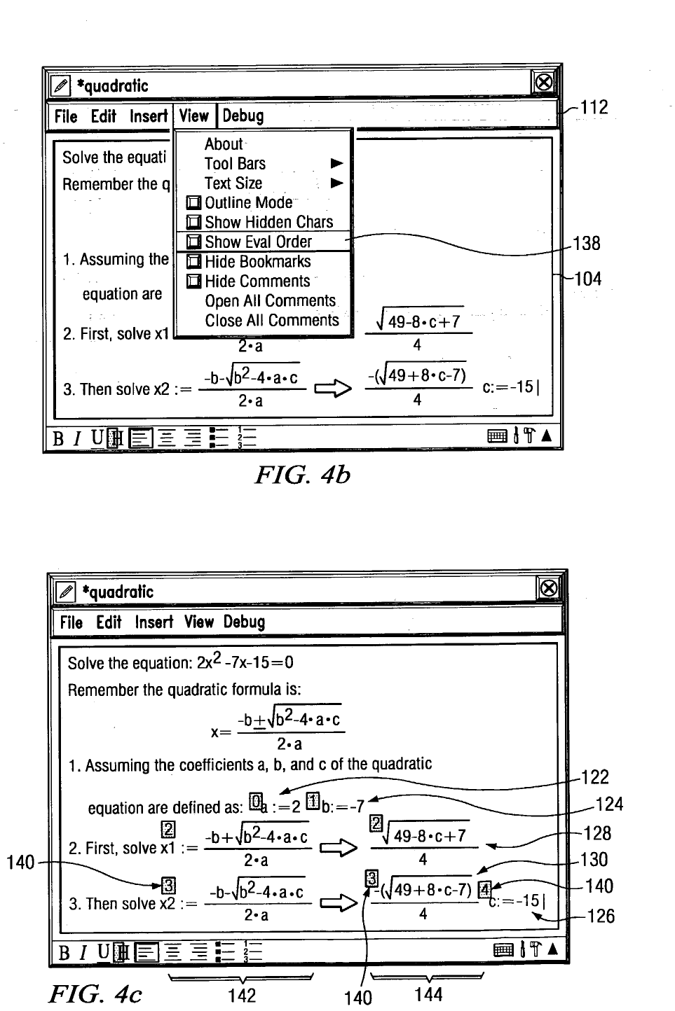

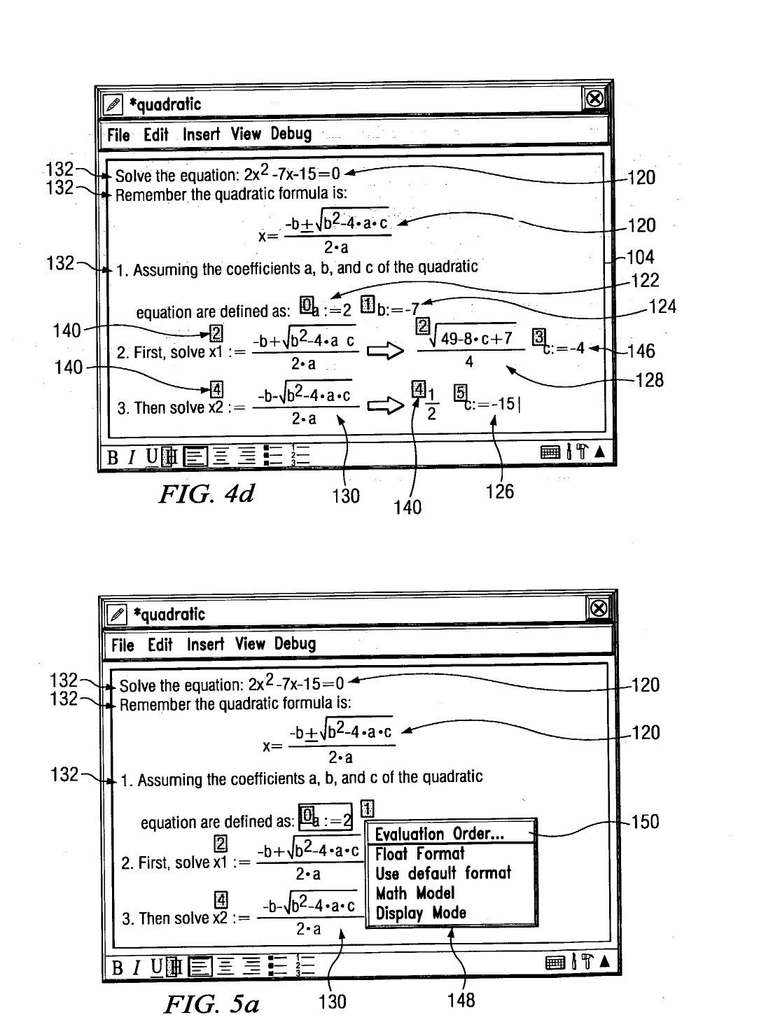

Another feature of embodiments of the present invention is the ability to change the evaluation order of the math content, e.g., a plurality of mathematical expressions, embedded within a text document. The evaluation order changes may be made implicitly or explicitly. The evaluation order is modified implicitly when the user moves an input mathematical expression to another position within the text document, changing the evaluation order of mathematical expressions in the text document accordingly, as shown in FIGS. 4a to 4d. Implicit changing of the evaluation order of mathematical expressions occurs when the user, using the stylus or external keyboard and mouse, selects a mathematical expression and moves it to another location in the text document. Explicit change of the evaluation order occurs when the user selects an evaluation order dialog bar, which shows the evaluation order, and the user changes it in the dialog bar. The evaluation order is initially tracked by the editor in a spatial manner, e.g., left to right, top to bottom, as the document is created. If the user changes the evaluation order implicitly, the evaluation order continues to be tracked spatially. However, once the evaluation order has been changed explicitly by the user, the editor changes to a temporal order of evaluation, e.g., dependent upon the time inserted, until globally reset (which resets the order spatially, left-right, top-down) or individually changed by the user.

FIG. 4a illustrates implicit evaluation order modification by the movement of the live mathematical expression for “c” 126 from FIG. 3a to another position within the text document, to a location after the mathematical expression for “x2” 130 in the document. Note that the results of live mathematical expressions 128 and 130 changed because “c” is defined (expression 126) after their definition, now. Thus, the results of mathematical expressions “x1” 128 and “x2” 130 are now expressed with respect to the undefined (in evaluation order) “c” variable.

FIG. 4b illustrates that a user may select an option, e.g., “Show Eval Order” button 138 from the top bar 112 menu. FIG. 4c shows what the user then views on the screen, with the evaluation order being shown by an update ordinal 140 (e.g., 0, 1, 2, 3, 4) in the upper left corner of each live mathematical expression. This illustrates why the live mathematical expressions 128 and 130 are evaluated differently after moving the definition of “c” (expression 126). Note that “c=15” (expression 126) is now the fourth expression (update ordinal=4) in the evaluation order; therefore, it is not used in the evaluation of any previous expression, such as expressions 128 and 130. Also note that live mathematical expressions that yield results, such as expressions 128 and 130, indicate the update ordinal on both the left side 142 and the right side 144 of the yield “=>” sign.

Preferably, when an object or mathematical expression is inserted, the evaluation order is automatically changed for the objects following the inserted object, as shown in FIG. 4d. A definition for the variable “c” (live mathematical expression 146) has been inserted before live mathematical expression for “x2”, 130. Note that the result for live mathematical expression 130 is now evaluated using this value for “c”.

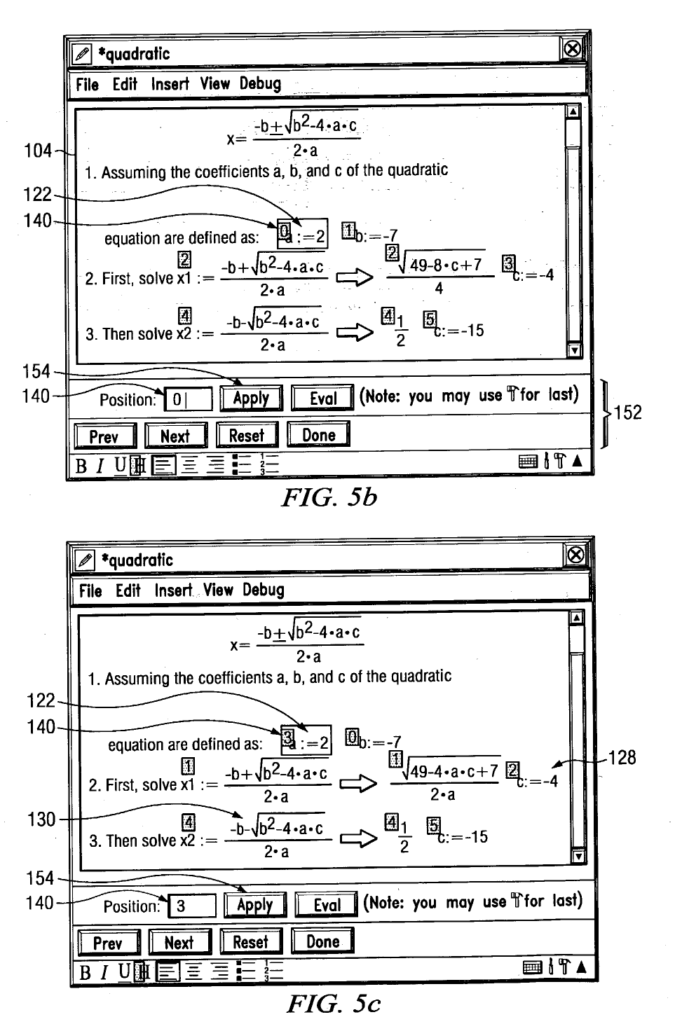

FIG. 5a illustrates explicit evaluation order modification. The user places the stylus on the expression to select it, taps and holds the expression with the stylus, to bring up a context menu 148, as shown. When the user selects the “Evaluation Order” button 150, then a docked dialog bar 152 is brought up at the bottom of the screen display area 104, as shown in FIG. 5b. The docked dialog bar 152 displays the current update ordinal 140, (indicated by “Position” in the docked dialog bar; 0 in this example) of the selected expression 122, and allows a user to manually edit the evaluation order of that expression, by changing the position number or update ordinal 140. For example, in FIG. 5c, the user has changed the position of live mathematical expression 122 to 3. Now, “a” is not defined with respect to the evaluation order for the live mathematical expression 128 and any other expressions before it. Thus, in this example, the result of expression 128 is now expressed with respect to undefined variable “a”, as well as “c”. Note that expression 122 is before expression 130 in the evaluation order; thus, the value of “a” is known before expression 130 is evaluated, and the result is a solution in actual numerical format rather than expressed with respect to variable “a”.

Note also that there is an Apply button 154 on the docked dialog bar 152, as shown in FIGS. 5b and 5c. The Apply button 154 gives the user the ability to view the changes to the evaluation order prior to actually performing a new evaluation, which is accomplished by tapping the Eval button 156, also located on the docked dialog bar 152, or by pressing the enter key while the cursor lies within any live mathematical expression.

The update ordinal (“position” in the docked dialog bar) is used to label each embedded object in the update sequence. For example, the user may select an object and specify its evaluation ordinal. Alternatively, the user may specify a different ordering by clicking on each object in the desired order, for example. After making any changes in the evaluation order, the other ordinals will be shifted. For example, if the user selects the object with ordinal 3 and assigns it ordinal 1, then the objects formerly having ordinals 1 and 2 will be given new ordinals 2 and 3, respectively.

In one embodiment of the present invention, the inputs and outputs of math expressions may be separated. This allows the user to insert text and other multimedia objects between the input of an expression and the output. For example, for a:−2 and b:=3, then the mathematical expression is represented as Eq. 1:

a\hat{ }2+b\hat{ }2=>13 Eq. 1

In accordance with an embodiment of the invention, the “a\hat{ }2+b\hat{ }2” left side of the yield sign “=>” in the equation may be separated from the answer (13) or right side of the yield sign by text or at least one multimedia object, for example. For example, the user may input text between the input and output of the mathematical expression, so that the document reads: “If a:=2 and b:=3, then the equation a\hat{ }2+b\hat{ }2 may be calculated to yield an answer of 13.” In the handheld device 100 (see FIG. 1), the representative string “a\hat{ }2+b\hat{ }2” is not just a textual representation of the equation, but is an active or “live” expression that is separable from its result “13”. Similarly, the expressions a:=2 and b:=3 are also live expressions. Thus, inputs and outputs of live mathematical expressions may be separated, with text and other multimedia objects inserted between them.

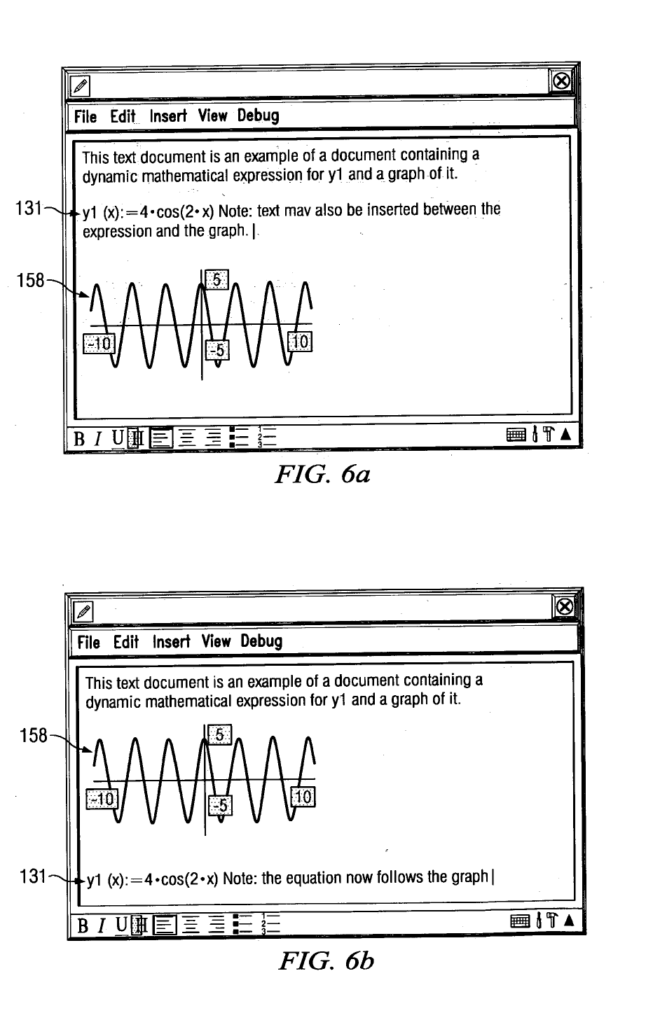

FIG. 6a shows a multimedia object, in particular, a graph 158 that is embedded in a text document in accordance with an embodiment of the invention. The graph 158 showing the results of live mathematical expression 131 embedded in the text document may be moved or inserted before the mathematical expression 131 within the text document, as shown in FIG. 6b. If the user changes variables in the mathematical expression 131, the graph 158 changes accordingly. Note that the evaluation order ordinal of the graph 158 must be greater than that of the equation 131 it represents in order to reflect the variable changes.

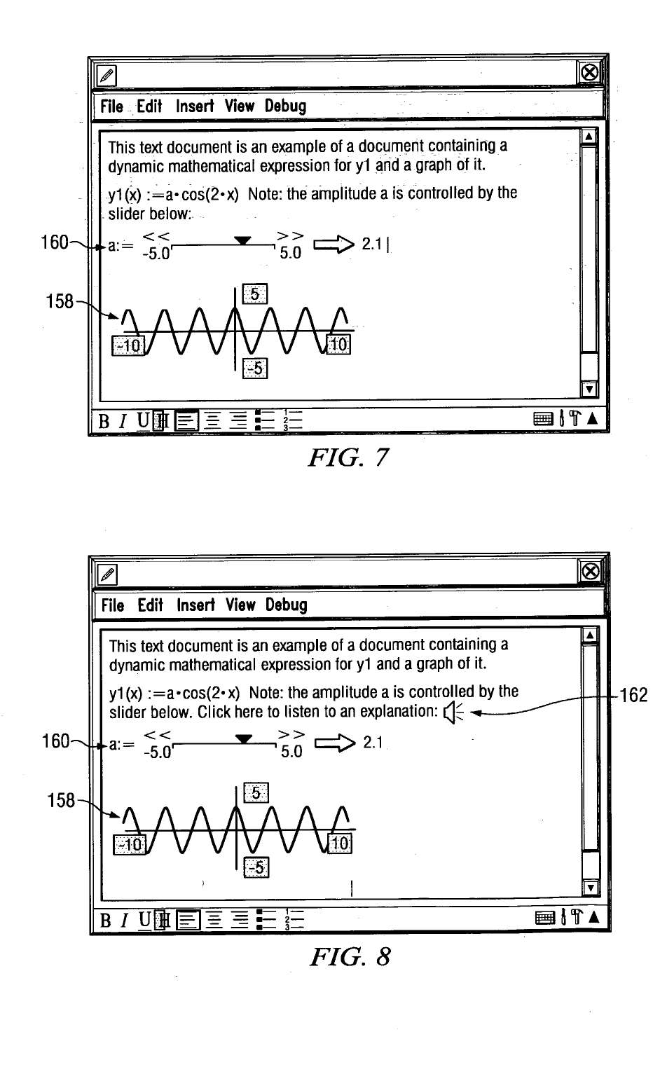

FIG. 7 shows a multimedia object comprising a math slider 160 for a variable of the graph shown in FIG. 6a that is inserted within the text document. In this example, a coefficient is changed from a constant to a variable, e.g., 4 to “a”. Now, a user can use the slider 160 to vary the value of the variable “a”. Math sliders 160 may be used for variables of an equation so that the user may click on the slider and easily move the slider 160, changing the value of the variable. The impact on the result of the mathematical expression may be viewed numerically and/or graphically by the user. For example, the slider 160 may be used to change a coefficient in a mathematical expression, such as the amplitude or frequency of a function. Note that multimedia objects such as graphs 158 and sliders 160 may be dynamic mathematical expressions that are included in the evaluation order of the text document. Like graphs 158, in accordance with an embodiment of the present invention, math sliders 160 may be inserted anywhere the user would like within the text document. The evaluation order of graphs 158 and sliders 160 may be changed explicitly or implicitly. The slider 160 can represent a variable in one or more dynamic mathematical expressions, wherein moving the slider changes the results of all dynamic mathematical expressions that depend on the variable through a direct or indirect (e.g. through another expression) relationship.

FIG. 8 illustrates a multimedia object, in this case, an audio clip icon 162 embedded within a text document, in accordance with an embodiment of the present invention. A user of the device 100 may click on the audio clip icon 162, which will automatically play an associated sound file. Similarly, other multimedia objects that may be inserted by a user include static images, text objects, video clips, and information from data collection devices, as examples (not shown). Other types of multimedia objects may similarly be embedded within a text document. The information may be collected from a data collection device such as a Calculator-Based Laboratory™ (CBL) device having sensors and/or probes for collecting data, such as sound waves, temperature, distance, pH, pressure, force, motion, gas, light, radiation, humidity, heart rate, current, or voltage, as examples. The various objects embedded within the text document may interact with one another. For example, a mathematical expression may have a slider control for one of its variables and the result of the expression may be represented as the sound wave of the audio clip 162.

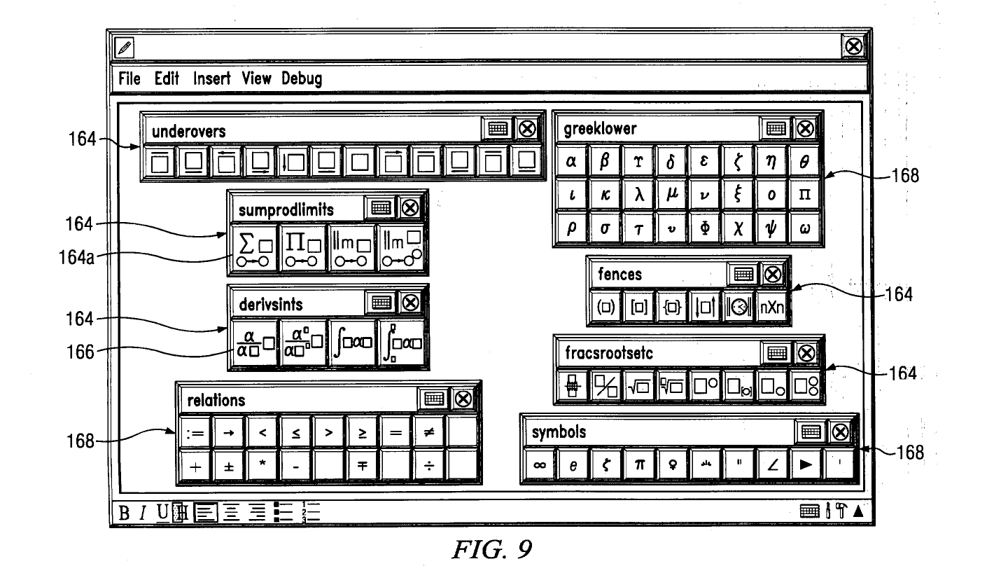

Users can choose from a palette of mathematical patterns 164 and symbols 168 that is stored in the memory 196 of the device 100 (see FIG. 14). The patterns may be used to create a mathematical expression for a particular application. Alternatively, the user may create custom patterns and add them to the palette. FIG. 9 illustrates a list of available mathematical patterns 164 and symbols 168 that can be viewed and selected by the user to create static or dynamic mathematical expressions. The mathematical patterns 164 may include patterns such as derivatives, integrals, summations, products, limits, absolute value, matrices, and lists, as examples. The patterns 164 comprise subexpressions 166 that must be supplied by the user, such as limits, integrands and other mathematical expressions. The symbols 168 may include Greek lower and upper symbols, constants, and operators, for example.

Preferably the editor 101 (see FIG. 14) utilizes an object oriented extension architecture, along with XML as its data format. XML is an Extensible Markup Language that defines a generic syntax that is used to represent data with simple human-readable tags. XML is a language for defining other languages. Examples of XML compatible language applications includes XHTML, MathML, QTI, and SVG, as examples. A wide range of libraries in a variety of languages are able to read and write XML compatible data, making it particularly useful in embodiments of the present invention. Alternatively, other types of software may be used in the editor of embodiments of the present invention.

When a user selects the summation pattern 164a in FIG. 9, a two-dimensional pattern definition and a one-dimensional semantic representation of the two-dimensional pattern definition are simultaneously created. The XML code preferably represents both the two-dimensional and one-dimensional information.

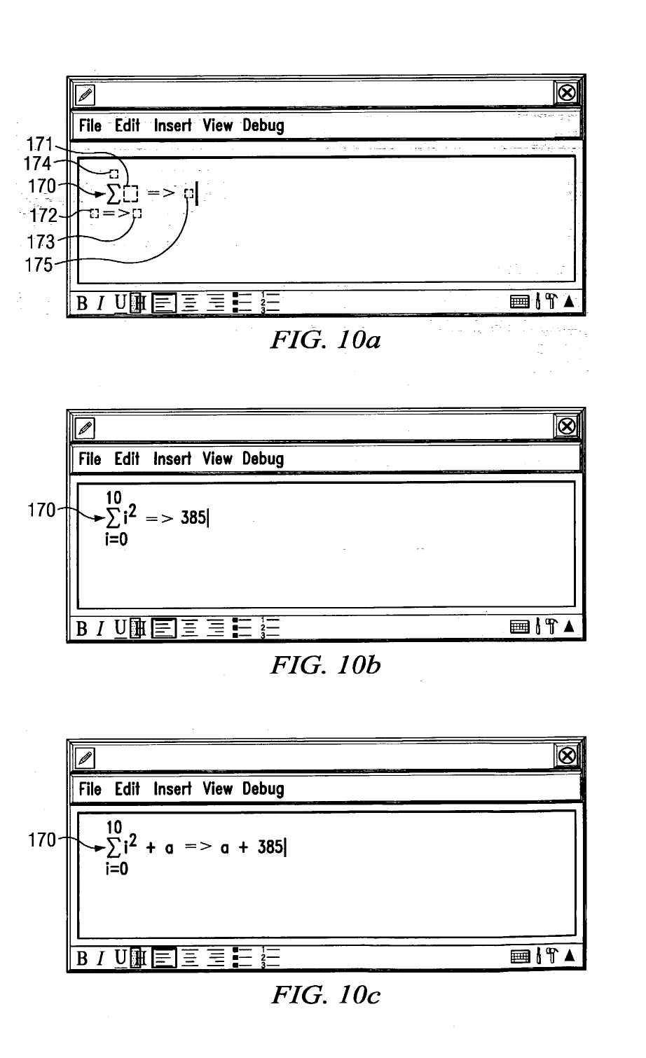

FIG. 10a shows a pattern 170 for a mathematical summation. The pattern 170 includes a summation sign, locations for a subexpression 171 (the summand), an index variable 172, a “from” subexpression 173, and a “to” subexpression 174. These subexpressions are blank because they need to be supplied by the user, to be described further herein. A location for a result 175 is also reserved in the pattern 170.

The XML Representation Example 1 below shows XML-compatible data for the pattern 170 shown in FIG. 10a. The internal data is preferably XML compatible, and such as XHTML or MathML, as examples. Embodiments of the present invention provide the user with the ability to edit the mathematical expression 170. The mathematical expression 170 may be selected, and as the mathematical expression 170 is edited, the edit details are included in the XML compatible data in memory 196.

XML Representation Example 1:

```
<html xmlns=‘http://www.w3.org/1999/xhtml’
xmlns:m=‘http://www.w3.org/1998/Math/MathML’
xmlns:ti=‘http://www.ti.com/2003/Scribe’>
  <head>
    <title>fig12a</title>
    <link rel=‘stylesheet’ href=‘/dis/scribe/res/stylesheets/default.css’
type=‘text/css’></link>
    <script language=‘JavaScript1.2’
src=‘/dis/scribe/res/scripts/comments.js’></script>
    <object id=‘MathPlayer’ classid=’clsid:32F66A20-7614-11D4-BD11-
00104BD3F987’></object>
    <?import namespace=‘m’ implementation=‘#MathPlayer’?>
  </head>
  <body>
    <p>
      <m:math class=‘input’ tiinput=‘0’>
        <m:mrow tiarg=‘0’>
          <m:mrow tipattern=‘sum(%s,%s,%s,%s)’ tiapplypos=‘0’
          tiinsertpos=‘1’>
            <m:munderover tiindexable=‘false’>
              <m:mo tiindexable=‘allfalse’>&Sum;</m:mo>
              <m:mrow tiindexable=‘false’>
                <m:mrow tiarg=‘1’></m:mrow>
                <m:mo tiindexable=‘allfalse’>=</m:mo>
                <m:mrow tiarg=‘2’></m:mrow>
              </m:mrow>
              <m:mrow tiarg=‘3’></m:mrow>
            </m:munderover>
            <m:mrow tiarg=‘0’></m:mrow>
          </m:mrow>
        </m:mrow>
      </m:math>
      <m:math class=‘delim’ tiindexable=‘childfalse’>
        <m:mspace width=‘4px’></m:mspace>
        <m:mo form=‘prefix’>&DoubleRightArrow;</m:mo>
        <m:mspace width=‘4px’></m:mspace>
      </m:math>
      <m:math class=‘output’ tioutput=‘0’>
        <m:mrow tireadonly=‘1’ tiarg=‘0’></m:mrow>
      </m:math></p>
  </body>
</html>
```

The 1D Example 1 below shows the unfinished one-dimensional representation that is derived from the above XML representation that, in a finished form, will ultimately be sent to the CAS to be evaluated.

### 1D EXAMPLE 1

sum(,,,)

Note that the end user does not need to see the XML or 1D representations on the screen, they only need to see and interact with the graphical representation (in 2D format) shown in FIG. 10a. The internal XML is the source of and represents both the 2D and 1D representations. Both the XML and 1D representations are shown to illustrate that as the user edits the 2D representation, the 1D representation is producible from the XML compatible data, and may be sent to the CAS. In accordance with a preferred embodiment of the invention, the XML compatible data is maintained and updated as the user edits 2D patterns on the screen. The XML compatible data is stored in the memory of the computing device.

FIG. 10b illustrates the expression of FIG. 10a after the user has supplied the inputs for the pattern subexpressions. The XML Representation Example 2 below shows XML-compatible data for the edited pattern shown in FIG. 10b.

XML Representation Example 2:

```
<html xmlns=‘http://www.w3.org/1999/xhtml’
xmlns:m=http://www.w3.org/1998/Math/MathML’
xmlns:ti=‘http://www.ti.com/2003/Scribe’>
  <head>
    <title>fig12a</title>
    <link rel=‘stylesheet’ href=‘/dis/scribe/res/stylesheets/default.css’
type=‘text/css’></link>
    <script language=‘JavaScript1.2’
src=‘/dis/scribe/res/scripts/comments.js’></script>
    <object id=‘MathPlayer’ classid=‘clsid:32F66A20-7614-11D4-BD11-
00104BD3F987’></object>
    <?import namespace=‘m’ implementation=‘#MathPlayer’?>
  </head>
  <body>
    <p>
      <m:math class=‘input’ tiinput=‘0’>
        <m:mrow tiremovable=‘false’ tiarg=‘0’>
          <m:mrow tipattern=‘sum(%s,%s,%s,%s)’ tiapplypos=‘0’
          tiinsertpos=‘1’>
            <m:munderover tiindexable=‘false’>
              <m:mo tiindexable=‘allfalse’>&Sum;</m:mo>
              <m:mrow tiindexable=‘false’>
                <m:mrow tiarg=‘1’>
                  <m:mi>i</m:mi>
                </m:mrow>
                <m:mo tiindexable=‘allfalse’>=</m:mo>
                <m:mrow tiarg=‘2’>
                  <m:mn>0</m:mn>
                </m:mrow>
              </m:row>
              <m:mrow tiarg=‘3’>
                <m:mn>10</m:mn>
              </m:mrow>
            </m:munderover>
            <m:mrow tiarg=‘0’>
              <m:msup tipattern=‘(%s)\hat{ }(%s)’ tiinsertpos=‘1’>
                <m:mrow tiarg=‘0’>
                  <m:mi>i</m:mi>
                </m:mrow>
                <m:mrow tiarg=‘1’>
                  <m:mn>2</m:mn>
                </m:mrow>
              </m:msup>
            </m:mrow>
          </m:mrow>
        </m:mrow>
      </m:math>
      <m:math class=‘delim’ tiindexable=‘childfalse’>
        <m:mspace width=‘4px’></m:mspace>
        <m:mo form=‘prefix’>&DoubleRightArrow;</m:mo>
        <m:mspace width=‘4px’></m:mspace>
      </m:math>
      <m:math class=‘output’ tioutput=‘0’>
        <m:mrow tireadonly=‘true’ tiarg=‘0’>
          <m:mn>385</m:mn>
        </m:mrow>
      </m:math></p>
  </body>
</html>
```

The 1D Example 2 below shows the finished one-dimensional representation that is derived from the above XML representation that is sent to the CAS to be evaluated. The CAS sends the results back to the editor, in the XML compatible format, and then the result is displayed on the screen.

### 1D EXAMPLE 2

sum((i)\hat{ }(2),i,0,10)

FIG. 10c shows the mathematical expression of FIG. 10b after a user has modified it. The user has edited the expression 164 to include “+a”. The XML Representation Example 3 below shows XML-compatible data for the edited pattern shown in FIG. 10c.

XML Representation Example 3:

```
<html xmlns=‘http://www.w3.org/1999/xhtml’
xmlns:m=‘http://www.w3.org/1998/Math/MathML’
xmlns:ti=‘http://www.ti.com/2003/Scribe’>
  <head>
    <title>fig12a</title>
    <link rel=‘stylesheet’ href=‘/dis/scribe/res/stylesheets/default.css’
type=‘text/css’></link>
    <script language=‘JavaScript1.2’
src=‘/dis/scribe/res/scripts/comments.js’></script>
    <object id=‘MathPlayer’ classid=‘clsid:32F66A20-7614-11D4-BD11-
00104BD3F987’></object>
    <?import namespace=‘m’ implementation=‘#MathPlayer’?>
  </head>
  <body>
    <p>
      <m:math class=‘input’ tiinput=‘0’>
        <m:mrow tiremovable=‘false’ tiarg=‘0’>
          <m:mrow>
            <m:mrow tipattern=‘sum(%s,%s,%s,%s)’ tiapplypos=‘0’
            tiinsertpos=‘1’>
              <m:munderover tiindexable=‘false’>
                <m:mo tiindexable=‘allfalse’>&Sum;</m:mo>
                <m:mrow tiindexable=‘false’>
                  <m:mrow tiarg=‘1’>
                    <m:mi>i</m:mi>
                  </m:mrow>
                  <m:mo tiindexable=‘allfalse’>=</m:mo>
                  <m:mrow tiarg=‘2’>
                    <m:mn>0</m:mn>
                  </m:mrow>
                </m:mrow>
                <m:mrow tiarg=‘3’>
                  <m:mn>10</m:mn>
                </m:mrow>
              </m:munderover>
              <m:mrow tiarg=‘0’>
                <m:msup tipattern=‘(%s)\hat{ }(%s)’ tiinsertpos=‘1’>
                  <m:mrow tiarg=‘0’>
                    <m:mi>i</m:mi>
                  </m:mrow>
                  <m:mrow tiarg=‘1’>
                    <m:mn>2</m:mn>
                  </m:mrow>
                </m:msup>
              </m:mrow>
            </m:mrow>
            <m:mo>+</m:mo>
            <m:mi>a</m:mi>
          </m:mrow>
        </m:mrow>
      </m:math>
      <m:math class=‘delim’ tiindexable=‘childfalse’>
        <m:mspace width=‘4px’></m:mspace>
        <m:mo form=‘prefix’>&DoubleRightArrow;</m:mo>
        <m:mspace width=‘4px’></m:mspace>
      </m:math>
      <m:math class=‘output’ tioutput=‘0’>
        <m:mrow tireadonly=‘true’ tiarg=‘0’>
          <m:mrow>
            <m:mi>a</m:mi>
            <m:mo>+</m:mo>
            <m:mn>385</m:mn>
          <m:mrow>
        </m:mrow>
      </m:math></p>
  </body>
</html>
```

The 1D Example 3 below shows the finished one-dimensional representation that is derived from the above XML representation that is sent to the CAS to be evaluated. The CAS sends the results back to the editor, in the XML compatible format, and then the result is displayed on the screen.

### 1D EXAMPLE 3

sum((i)\hat{ }(2),i,0,10)+a

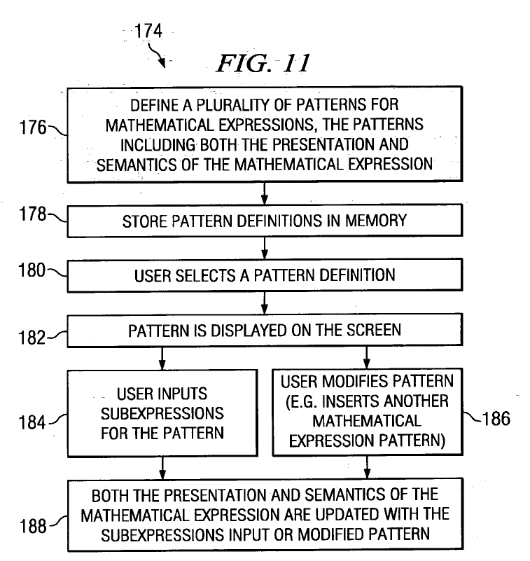

FIG. 11 shows a flow chart for a pattern-editing algorithm in accordance with an embodiment of the invention. A plurality of patterns for mathematical expressions are defined, wherein the patterns include both the presentation and semantics of the mathematical expression (step 176). The pattern definitions are stored in memory (step 178). The user selects a pattern definition (step 180), and the pattern is displayed on the screen (step 182). The user may either input subexpressions for the pattern selected (step 184), and/or modify the pattern, for example, by inserting another mathematical expression pattern into the pattern (step 186). Both the presentation and semantics of the mathematical expression are updated with the subexpressions input or modified pattern (step 188).

Advantageously, a selected pattern definition may be edited to create a custom pattern definition using the user interface. The XML-compatible data is edited when the selected pattern definition is edited. An output of the pattern definition is generated by the XML-compatible data, which is then sent to the display screen and is then viewable by the user. If the user has modified the pattern to create a custom pattern, it may be added to the palette of patterns.

A preferred embodiment of the handheld device editor 101 (the editor is stored in memory 196; see FIG. 14) will next be described. The system includes a rich text, e.g., multi-media, document editor, which tightly integrates patterns of glyphs, e.g., 2D mathematical expressions, within the text-editing environment. Mathematical expressions are treated as if they are large characters having their own alignment rules, rather than being treated as separate components that must be activated in order to edit or interact therewith.

The editor 101 software preferably comprises an object oriented based programming languages such as Java or C++, as examples. The editor 101 consumes and produces XML compatible data such as MathML, XHTML, and other XML language applications.

In order to reduce memory consumption, preferably the editor 101 consolidates character streams with the same formatting adornments into a single object instance, rather than every character being a separate object, e.g., a glyph. The editor 101 preferably uses a flyweight design architecture with respect to XML entities and element types, for example.

Preferably, logic is utilized to insure that only the necessary portions of the text document are actually invalidated and rendered accordingly. The editor 101 preferably implements a hit testing algorithm using a combination of recursive tree traversal and linear child search with an average time of O (log n).

The editor 101 preferably may be extended and customized without rebuilding the core source code. Preferably, the menus, toolbars, strings, patterns, and dialogs in the editor are described in XML. The patterns comprise XML templates that follow certain rules for describing which pieces of the template are to be modified by the user and used as arguments to a built-in math function. The patterns are not limited to mathematical expressions; patterns may also be used to implement different types of data supported by the editor 101.

Thus, without writing any code, a new pattern may be generated comprising existing patterns and/or custom XHTML/MathML, and these patterns may be inserted into existing toolbars or menus. Alternatively, custom glyphs may be written in the editor programming language to extend the system by implementing a glyph interface. A minimal slave based glyph can easily be implemented by simply writing two fundamental functions: “recalcNode” and “drawNode”, as examples. If a more interactive object is needed, then an additional “handleMsg” function may be fleshed out to handle system events such as focus, activation, pointer movement, and keystrokes. Other object oriented applications may be ported to the editor 101 by providing a thin wrapper that implements the glyph interface and handles the activate and deactivate messages.

The editor 101 is preferably scriptable and supports an extensive string based command language that may be called via embedded XHTML forms controls or via another mechanism. The glyph editor 101 exposes this string interface as a module that may be loaded into another application. Event notifications may be sent back to the calling application via an optional interface.

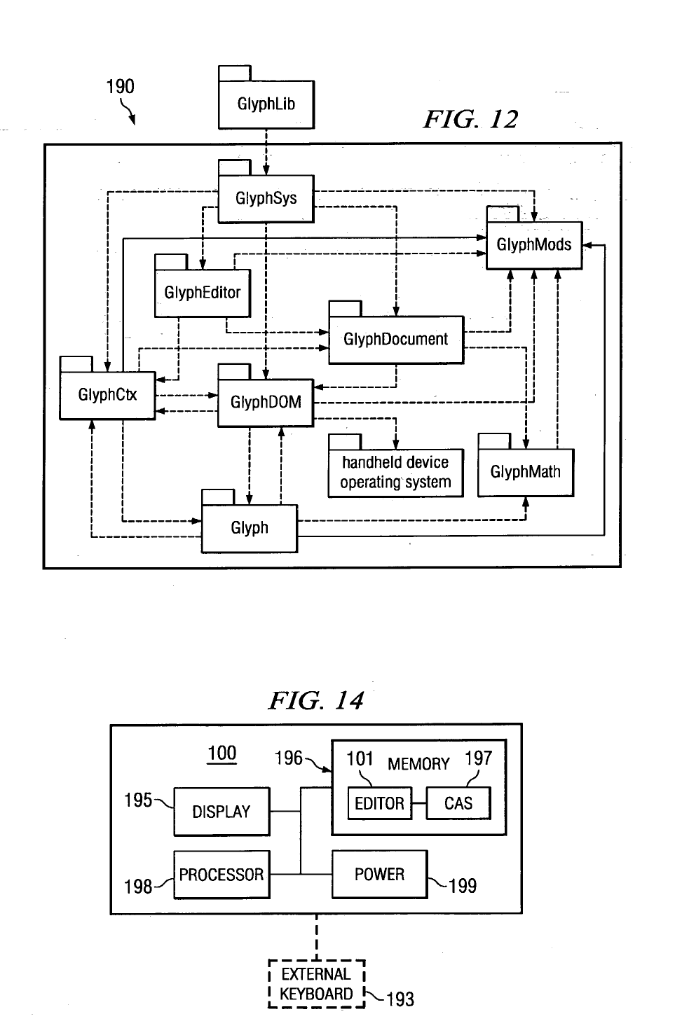

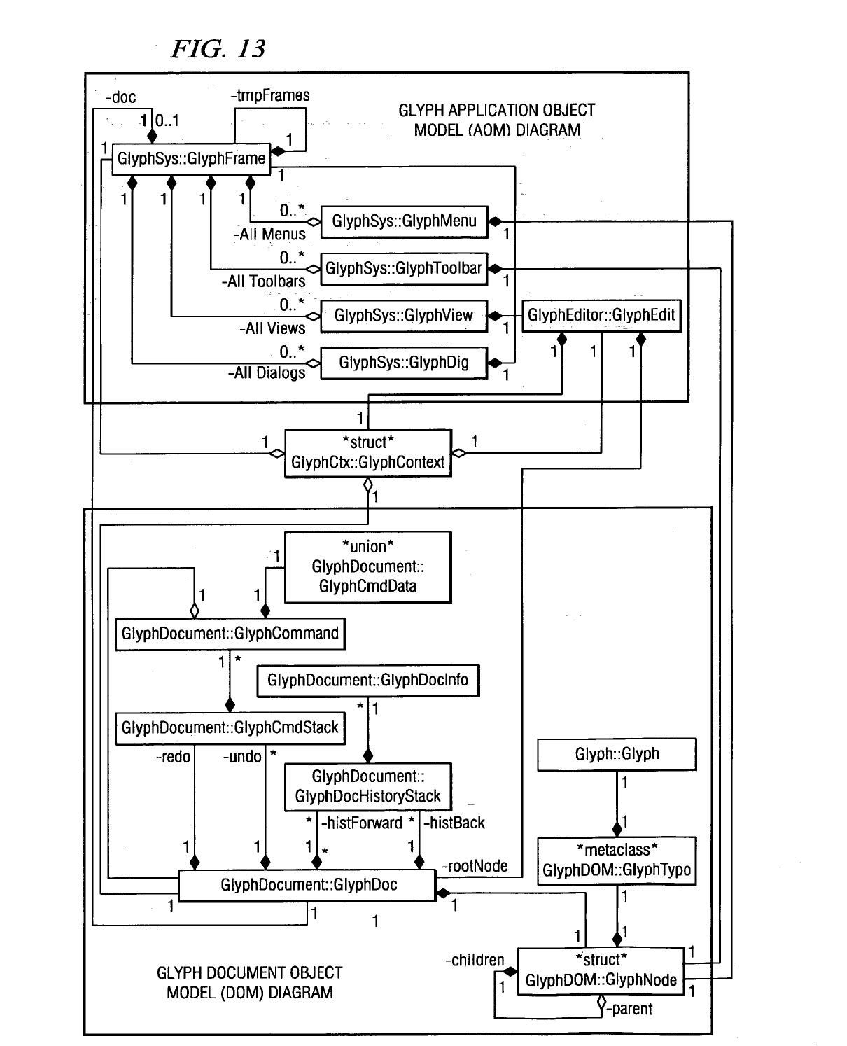

A preferred architecture 190 for the editing software 101 of the computing device 100 will next be described with reference to FIG. 12, which illustrates a block diagram of a preferred system architecture of the editor 101. FIG. 13 illustrates a more detailed view of the block diagram of FIG. 12, showing the Application Object Model (AOM) and document object model (DOM). The AOM implements a classical document/view architecture found in many object oriented application frameworks. The AOM preferably comprises a mainframe component that implements a single document interface and handles all of the application level commands. The main frame preferably manages other subcomponents including menus, toolbars, and multiple views of the same document. Each view has a reference to the same document; however, each view provides its own editing environment, which allows different portions of the same document to be viewed and edited concurrently.

Much of the AOM code is preferably operating system specific code and resides in GlyphSys (see FIG. 12), which comprises a module of code. However, most of the editing logic is preferably implemented by GlyphEditor and GlyphDocument and is designed to be AOM-independent. The GlyphView (FIG. 13) preferably binds to the pointer, key, and configuration events, then calls the appropriate commands in the editor, which may change the document. When the contents of the document are modified by any means (i.e., via a view or a Glyph extension), the document notifies the main frame, which takes the responsibility of updating all the views it is managing.

The Glyph Document Object Model (DOM) is preferably based on the standard XML DOM and is influenced by the MathML DOM. A Simple API XML (SAX) Parser may be used to read XML files and build the Glyph DOM node tree.

The DOM code is found in the GlyphDOM module and it provides a way to implement polymorphism and inheritance in a language that may not support it natively. Node instances should contain a reference to a GlyphType, which is a flyweight approach to sharing runtime type information and defining the class hierarchy. Each GlyphType has a unique name, a reference to a module that implements the Glyph interface for the given type, and an optional reference to a basetype that it wishes to inherit most of its functionality from. One advantage of this approach is that node types may be changed at runtime after creation. Furthermore, the actual class hierarchy is defined and can be extended at runtime rather than compile time.

GlyphCtx (context) (FIG. 12) provides a runtime context that represents the current states of the entire system. It is used by instances of a GlyphNode (FIG. 13) during message handling, drawings, and calculation of node metrics. A reference to a single instance of GlyphCtx is passed as a parameter to the Glyph interface methods. GlyphNodes are preferably organized in an acyclic tree with a single root managed by a single instance of GlyphDoc.

GlyphDoc provides high-level document manipulation methods, undo/redo stack management, selection/caret management, and evaluation of mathematical expressions including symbol table support via a Math Server Client (MSC) reference. GlyphDoc also synchronously notifies the main frame of certain state changes and provides XML persistence. GlyphDoc also provides back/forward history management and navigation for hyperlinks, and Open e Book (OEB) package information management and navigation.

There are other features that may also be incorporated into the editor 101. Preferably, the editor 101 includes an edit undo/redo feature that extends backwards and forwards for many edits made by the user. Preferably, every edit, including mathematical expressions and also portions of text, may be corrected using the undo/redo feature of the handheld device 100. Alternatively, a fixed number of recent edits may be corrected using the undo/redo feature. Other features of desktop computer word processors are preferably implemented within the handheld device editor 101, such as find/replace, bullets, comments, hyperlinks, bookmarks, outlining, and numbered lists, as examples.

FIG. 14 shows a block diagram of computing device 100 adapted to implement the editor 101, in accordance with embodiments of the invention. In some embodiments described herein, preferably the computing device 100 comprises a handheld computing device, that is, the housing has dimensions such that the handheld computing device may be operated while being held in the hand of a user. The device 100 includes a display 195 that is preferably interactive so that the user can activate and enter commands and edit a document with a stylus, for example. Alternatively, an external keyboard 193 may be used to edit a document. The device 100 includes memory 196, a processor 198, and a power source 199 which may comprise a rechargeable battery, for example. Software for the editor 101 and the CAS 197 is stored in memory 196. The editor 101 logic and mathematical functions are calculated using the processor 198.

Embodiments of the invention also include a method for combining text documents with objects such as mathematical and multimedia objects using the handheld computing device described herein. Another embodiment includes a method of changing the evaluation order of at least two mathematical expressions embedded within a text document. Another embodiment includes a method of changing static mathematical expressions to dynamic mathematical expressions, or vice versa, that are embedded within a text document. Another embodiment includes a method of separating the input and output of dynamic mathematical expressions embedded within a text document.

Embodiments of the computing device 100 and methods described herein provide technical advantages by providing a handheld device 100 that has an editor 101 that permits the embedding of non-text objects such as mathematical expressions and multimedia objects within a text document. This is particularly useful in an educational setting, wherein a teacher can insert mathematical equations and graphs in a text document to provide explanations to students. Graphs can precede equations within the documents and non-text objects may interact with one another or with mathematical expressions, giving more flexibility in the preparation of documents and presentations.

Other advantages include the ability to implicitly or explicitly change the evaluation order of mathematical expressions embedded within text documents on a computing device. Mathematical expressions may be moved around in a document and the evaluation order may be implicitly updated as the expressions are moved. Alternatively, the user may explicitly set the evaluation order, which allows a user to move antecedent data to an appendix and to organize the visual layout of the document however the user desires. The inputs of mathematical expressions can be separated from the outputs. Dead math may be converted to live math, and vice versa. Another advantage is the ability to undo and redo edits to mathematical expressions and text using an undo/redo function.

Although embodiments of the present invention and the advantages thereof have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that the computing device and editing software architecture and features may be varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, means, methods, or steps presently existing or later to be developed, that perform substantially the same function or achieve substantially the same result as the corresponding embodiments described herein may be utilized according to the present invention. Accordingly, the appended claims are intended to include within their scope such processes, machines, means, methods, or steps.

What is claimed is:

1. A computing device, comprising:
memory adapted to store software for creating and editing a document comprising text and at least two mathematical expressions embedded within the document, the mathematical expressions having a first evaluation order;
a processor adapted to run the software; and
a user interface, wherein the user interface may be activated to create and edit the document while at least portions of the document are displayed on a display screen, and wherein the user interface may be used to explicitly modify the first evaluation order to a second evaluation order, wherein the second evaluation order is different from the first evaluation order.

2. The computing device according to claim 1, wherein the evaluation order of the mathematical expressions is modifiable by activating an edit evaluation order mode and making the modification.

3. The computing device according to claim 1, wherein the document further comprises a graph, wherein the graph is representative of one of the mathematical expressions, wherein the graph may be placed before the represented mathematical expression within the document.

4. A computing device, comprising:
memory adapted to store software for creating and editing a document comprising text and at least one mathematical expression embedded within the document, wherein the mathematical expression comprises a static mathematical expression or a dynamic mathematical expression, wherein a static mathematical expression is visually distinguishable from a dynamic mathematical expression;
a processor adapted to run the software; and
a user interface, wherein the user interface may be activated to create and edit the document while at least portions of the document are displayed on a display screen, wherein a dynamic mathematical expression may be converted to a static mathematical expression, and wherein a static mathematical expression may be converted to a dynamic mathematical expression, using the user interface.

5. The computing device according to claim 4, wherein a static mathematical expression appears on the display screen in a different color than a dynamic mathematical expression.

6. A computing device, comprising:
memory adapted to store software for creating and editing a document comprising text and at least one dynamic mathematical expression embedded within the document, wherein the dynamic mathematical expression has an input and an output;
a processor adapted to run the software; and
a user interface, wherein the user interface may be activated to create and edit the document while at least portions of the document are displayed on a display screen, wherein the input and output of the dynamic mathematical expression may be separated by text or at least one multimedia object using the user interface.

7. The computing device according to claim 6, wherein the input and output are reversible.

8. A computing device, comprising:
a display screen;
memory adapted to store software for creating and editing a document comprising text and at least one mathematical expression;
a processor adapted to run the software; and
a user interface, wherein the user interface maybe activated to create and edit the document while at least portions of the document are displayed on the display screen, wherein the user interface provides a palette including a plurality of selectable mathematical patterns, and wherein selected mathematical patterns may be edited to create custom mathematical patterns using the user interface.

9. A handheld computing device, comprising:
a housing, the housing having dimensions such that the handheld computing device may be operated while being held in the hand of a user;
a display screen disposed on the exterior of the housing, the display screen including a user interface, wherein the user interface may be activated to create and edit the document while at least portions of the document are displayed;
memory adapted to store software for creating and editing a document comprising text and at least one dynamic mathematical expression; and
a processor adapted to run the software.

10. The handheld computing device according to claim 9, wherein the document further comprises at least one multimedia object, wherein the multimedia object comprises an interactive graph, a static image, a video image, audio information or information from data collection devices.

11. The handheld computing device according to claim 10, wherein the at least one multimedia object is interactive with the dynamic mathematical expression.

12. The handheld computing device according to claim 11, wherein the multimedia object comprises a slider, the slider representing a variable in one or more dynamic mathematical expressions, wherein moving the slider changes the results of all dynamic mathematical expressions that depend on the variable.

13. The handheld computing device according to claim 11, wherein the multimedia object comprises a graph, wherein the graph is representative of the dynamic mathematical expression, wherein the graph may be placed before the represented mathematical expression within the document.

14. The handheld computing device according to claim 9, wherein the user interface provides a palette including a plurality of selectable mathematical patterns.

15. The handheld computing device according to claim 9, wherein the dynamic mathematical expression may be viewed in a one-dimensional format, a two-dimensional format, or both.

16. The handheld computing device according to claim 9, wherein at least the dynamic mathematical expression may be edited using an undo/redo feature.

17. A method of creating and editing a document, comprising:
providing a handheld computing device, the handheld computing device including a user interface having a display screen, and editing software adapted to create a document comprising text and at least one dynamic mathematical expression;
creating text portions of the document; and
embedding the at least one dynamic mathematical expression within the text portions of the document.

18. The method according to claim 17, further comprising combining at least one multimedia object within the text portions of the document, wherein the multimedia object comprises an interactive graph, a static image, a video image, audio information or information from data collection devices.

19. The method according to claim 18, wherein the at least one multimedia object is interactive with the dynamic mathematical expression.

20. The method according to claim 18, wherein the multimedia object comprises a slider, the slider representing a variable in one or more dynamic mathematical expressions, wherein moving the slider changes the results of all dynamic mathematical expressions that depend on the variable.

21. The method according to claim 18, wherein the multimedia object comprises a graph, wherein the graph is representative of the dynamic mathematical expression, wherein the graph may be placed before the represented mathematical expression within the document.

22. The method according to claim 17, wherein the user interface provides a palette including a plurality of selectable mathematical patterns, further comprising:
selecting a mathematical pattern from the palette; and
inputting subexpressions into the mathematical pattern to form a mathematical expression.

23. The method according to claim 17, further comprising viewing the dynamic mathematical expression in a one-dimensional format, a two-dimensional format, or both.

24. The method according to claim 17, further comprising editing the dynamic mathematical expression using an undo/redo feature.

25. A method of creating and editing a document, comprising:
providing a computing device, the computing device including a processor, a user interface and memory storing editing software, wherein the computing device is adapted to create a document comprising text and at least two mathematical expressions having a first evaluation order;
creating text portions of the document;
embedding the at least two mathematical expressions within the text portions of the document; and
explicitly modifying the first evaluation order of the at least two mathematical expressions to a second evaluation order, wherein the second evaluation order is different from the first evaluation order.

26. A method of creating and editing a document, comprising:
providing a computing device, the computing device including a processor, a user interface and memory storing editing software adapted to create a document comprising text and at least one mathematical expression embedded within the document, wherein the mathematical expression comprises a static mathematical expression or a dynamic mathematical expression, wherein a static mathematical expression is visually distinguishable from a dynamic mathematical expression;
creating text portions of the document;
embedding the at least static or dynamic mathematical expression within the text portions of the document; and
converting the static mathematical expression to a dynamic mathematical expression, or converting the dynamic mathematical expression to a static mathematical expression.

27. A method of creating and editing a document, comprising:
providing a computing device, the computing device including a processor, a user interface and memory storing editing software adapted to create a document comprising text and at least one dynamic mathematical expression embedded within the document, the dynamic mathematical expression having an input and an output;
creating text portions of the document;
embedding the at least one dynamic mathematical expression within the text portions of the document; and
separating the input and output of the dynamic mathematical expression using the user interface.

28. A method of creating and editing a document, comprising:
providing a computing device, the computing device including a processor, a user interface and memory storing editing software adapted to create a document comprising text and at least one dynamic mathematical expression embedded within the document, the memory including a palette of selectable mathematical patterns;
creating text portions of the document;
selecting a mathematical pattern from the palette;
editing the mathematical pattern to create a custom mathematical pattern; and
storing the custom mathematical pattern in memory.

29. An algorithm for mathematical pattern selection within a document, comprising:
defining a plurality of mathematical patterns, each pattern definitions having at least one empty field for a sub-expression;
storing the pattern definitions in a computing device memory; and displaying the selectable plurality of pattern definitions on a user interface, wherein the user may select a pattern definition, wherein the user may enter a subexpression for the at least one empty field of the pattern definition using the user interface, and wherein as the user edits the pattern definition, a two-dimensional pattern definition and a one-dimensional semantic representation of the two-dimensional pattern definition are simultaneously created.

30. The algorithm according to claim 29, wherein the subexpression comprises a constant, variable, or another pattern.

31. The algorithm according to claim 29, wherein the two-dimensional pattern definition comprises XML-compatible data.

32. The algorithm according to claim 29, wherein a selected pattern definition may be edited to create a custom pattern definition using the user interface.

33. The algorithm according to claim 32, wherein the XML-compatible data is edited when the selected pattern definition is edited.

34. The algorithm according to claim 29, further comprising generating a one-dimensional semantic representation of the two-dimensional pattern definition.
